(19) United States
(12) Patent Application Publication
(10) Pub. No.: US 2020/0376665 A1
(43) Pub. Date: Dec. 3, 2020

(54) MONITORING ALGORITHM METHOD FOR MOVABLE SMART HOME MONITORING ROBOT

(71) Applicant: VARRAM SYSTEM CO., LTD., Yuseong-gu, (KR)

(72) Inventors: Byung Jo SUH, Yuseong-gu (KR); Kyoung Seok KIM, Yuseong-gu (KR)

(21) Appl. No.: 16/881,228

(22) Filed: May 22, 2020

(30) Foreign Application Priority Data
May 31, 2019 (KR) 10-2019-0064421

(51) Int. Cl. B25J 9/16; G06K 9/00

(52) U.S. Cl. CPC B25J 9/1674; G06K 9/00664; B25J 9/1602; B25J 9/1697

(57) ABSTRACT

The monitoring algorithm method of the movable smart home monitoring robot comprises the steps of: moving a main body by controlling the moving unit, acquiring images of the surrounding space in real time through the camera and, extracting and analyzing information about an indoor space using the image obtained through the camera.

### TECHNICAL FIELD

The present invention relates to a monitoring algorithm method of the Movable Smart Home Monitoring Robot, which can monitor an internal space of a home in real time and manage while moving.

### BACKGROUND ART

According to the global market analysis of the telepresence robot and forecasting report of Tractica, a global market research firm, telepresence robot shipments are expected to expand to 100,000 units by 2020, and as the fourth industrial revolution progresses in earnest, remote monitoring robots that can be in two spaces simultaneously without space constraints are expected to increase in importance.

### DISCLOSURE

### Technical Problem

The present invention is designed to solve the problems mentioned above and is designed to provide a monitoring algorithm method of the Movable Smart Home Monitoring Robot which can freely monitor any space such as a home, an office, a shopping mall, a building, etc. as the indoor space can be monitored.

### Technical Solution

According to an embodiment of the present invention, the monitoring algorithm method of the Movable Smart Home Monitoring Robot comprises the steps of: moving a main body by controlling the moving unit, acquiring images of the surrounding space in real time through the camera and, extracting and analyzing information about an indoor space using the image obtained through the camera.

### Advantageous Effects

According to the disclosed present invention, the space including the home, office, shopping mall, building etc. freely can monitor because the monitoring algorithm method of the Movable Smart Home Monitoring Robot characterizes to monitor the indoor space.

### DESCRIPTION OF DRAWINGS

FIG. 1 is a drawing for explaining a monitoring algorithm method of the Movable Smart Home Monitoring Robot according to an embodiment of the present invention.

FIGS. 2 to 4 are drawings to describe a method for monitoring algorithms of the Movable Smart Home Monitoring Robot according to an embodiment of the present invention.

### DETAILED DESCRIPTION OF THE PREFERRED EMBODIMENT

Hereinafter, the present invention will be described in detail with reference to the accompanying drawings.

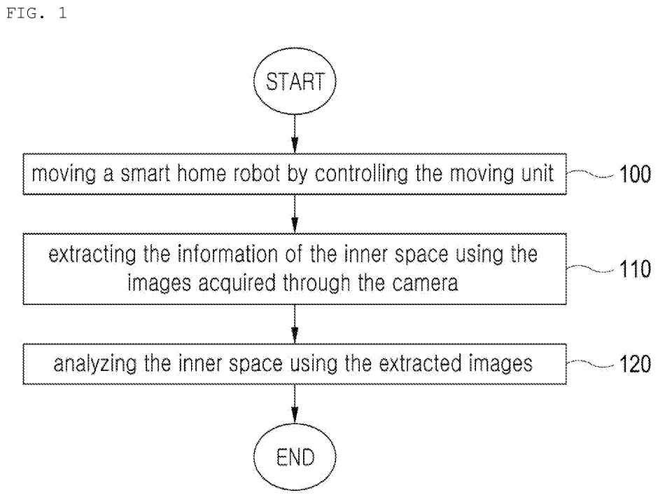

FIG. 1 is a drawing for explaining a monitoring algorithm method of the Movable Smart Home Monitoring Robot according to an embodiment of the present invention.

Referring to FIG. 1, a monitoring algorithm method of the Movable Smart Home Monitoring Robot may include a moving means, a camera, and a control unit.

The Movable Smart Home Monitoring Robot can be used as pet monitoring, baby monitoring, silver care and home security cameras, so they can see the house anytime, anywhere, even when they are outdoors, overtime, even during overseas business trips, and have the ability to talk to people at home.

In addition, the Movable Smart Home Monitoring Robot is equipped with a full HD camera with a wide angle, and a thermal image camera is installed as a basic, so various image recognition-based services are possible. Since the IoT is possible through user voice recognition or smart device control functions, the mobile smart home monitoring robot can be easily linked with the smart home system and used as a smart butler robot, not a simple security camera.

The means of movement may be means of moving the body of the robot, for example, the means of movement may include a configuration such as a wheel.

The camera can obtain the image. For example, the camera can acquire an image while rotating through the driving unit, or can acquire an image by merging the image obtained from two or more cameras in real time.

The Control unit can control configurations included in the Movable Smart Home Monitoring Robot.

The control unit can move the main body by controlling the mobile tool. The control unit can extract the information about the indoor space by using the image obtained through camera.

In order to use the obtained image, the control unit can analyze the indoor space.

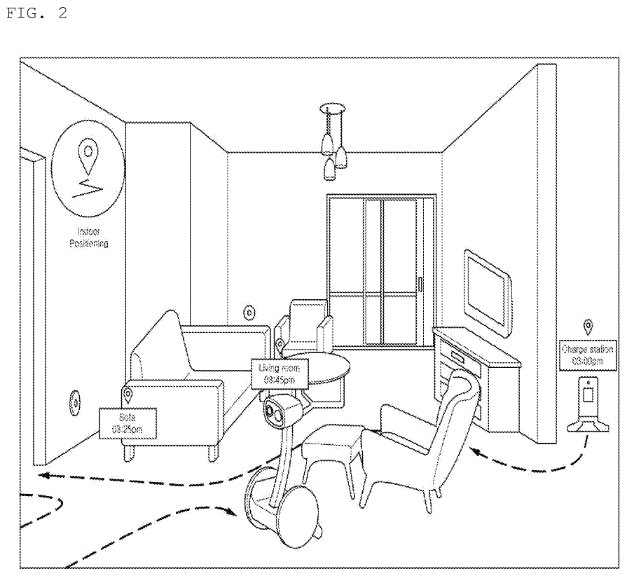

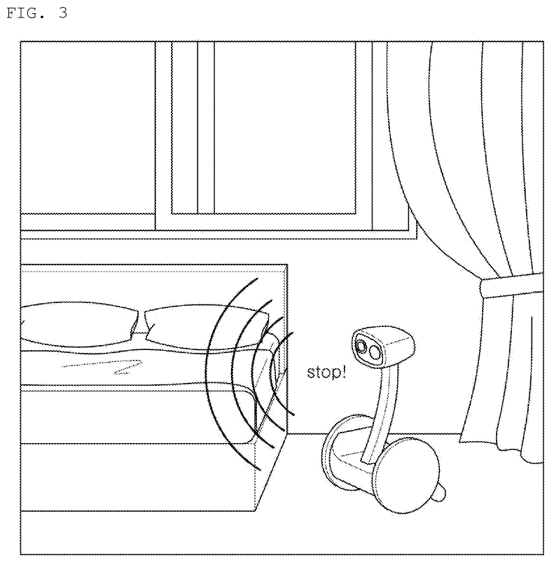

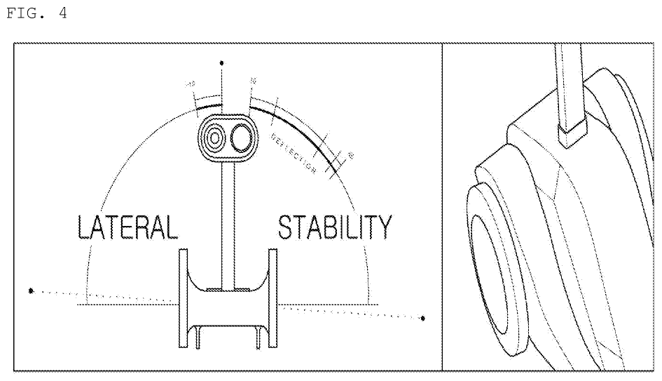

FIG. 2 to FIG. 4 are drawings to describe a method for monitoring algorithms of the Movable Smart Home Monitoring Robot according to an embodiment of the present invention.

Referring to FIG. 2 through FIG. 4, the Movable Smart Home Monitoring Robot can move main body by controlling the mobile tool. The Movable Smart Home Monitoring Robot can extract the information about the indoor space by using the image obtaining through camera.

The movable smart home monitoring robot can analyze indoor space to use obtained images. For example, the movable smart home monitoring robot can analyze the presence of an external invasion, a fire occurrence, etc. in real time by using the obtained image. The movable smart home monitoring robot can transmit the analyzed content with the terminal or server.

The movable smart home monitoring robot can move the indoors in response to the control event. For example, the movable smart home monitoring robot can move to a stored path based on registered information corresponding to a control event.

The movable smart home monitoring robot can receive the status information of the home device. For example, it can take photograph an image or video of a home device and receive a value measured by a sensor provided in the home device. In another embodiment, the movable smart home monitoring robot and a home device can be connected through wireless communication through local area communication, and status information of the home device can be received through wireless communication such as a power state, a battery state, a temperature, humidity, an opening/closing state, etc.

The home device transmits the status information to the robot control server, and the robot control server can transmit the received status information to the remote terminal. In an embodiment, a robot control server may store status information.

The remote terminal can output the received status information. For example, a remote terminal may receive information about an event generated in the home device through status information transmitted from the robot control server in response to an event generated in the home device. Also it can check the Home devices to be normally controlled.

The embodiments described above may be configured by selectively combining all or some of the embodiment such that various modifications may be made.

It should also be noted that the embodiments are for the purpose of illustration and not for the purpose of limitation. In addition, it will be understood by those of ordinary skill in the art that various embodiments are possible within the scope of the technical idea of the present invention.

1. A monitoring algorithm method for the movable smart home monitoring robot, comprising:
moving a main body by controlling the moving unit;
acquiring images of the surrounding space in real time through the camera; and
extracting and analyzing the information of the indoor space using the images acquired through the camera.
